(19) United States
(12) Patent Application Publication
(10) Pub. No.: US 2003/0033404 A1
(43) Pub. Date: Feb. 13, 2003

(54) Method for automatically monitoring a network

(76) Inventor: David E. Richardson, Ft. Collins, CO (US)

Correspondence Address: HEWLETT-PACKARD COMPANY, Intellectual Property Administration, P.O. Box 272400, Fort Collins, CO, 80527-2400, US

(21) Appl. No.: 09/925,861

(22) Filed: Aug. 9, 2001

(51) Int. Cl. G06F 15/173

(52) U.S. Cl. 709/224; 709/221

(57) ABSTRACT

A computer network has at least on computer operatively connected to an electronic device. The computer measures the response time for data transfers between the computer and the electronic device. The measured data response times are compared to preselected data response times and an indication is provided if the measured response time exceeds the preselected response time.

### TECHNICAL FIELD OF THE INVENTION

The present invention relates to monitoring a computer network and, more particularly, to notifying a network administrator of increased latency problems within the network.

### BACKGROUND OF THE INVENTION

A computer network links several computers together, which provides for data transfer and thus, communications, between the several computers. The computers within a network are often linked together via a plurality of devices including repeaters, switches, and routers. These devices serve to route data between selected computers within the network. For example, a data packet may originate at a first computer and may be intended to be transferred to a second computer. The devices within the network communicate with each other to establish a path for the transfer of data between the first computer and the second computer. The devices within a network that communicate with each other are sometimes referred to as network nodes or simply nodes.

A single network typically has a plurality of nodes that serve to increase the quantity of data that is able to be transferred within the network. The plurality of nodes within the network also enables the size of the network to be increased by linking several computers to a single node and providing for node to node data transfers. For example, several computers may be linked to a router and several routers may be linked together. Thus, data may originate at a first computer and transfer through a plurality of routers and other nodes before it is ultimately transferred to a second computer. The time required for data to transfer from one node to another node within the network is sometimes referred to as the latency.

At least one server is often located within the network. One example of a server is a computer that stores data and runs applications that are common to other computers within the network. For example, a mail server may be a component of the network and may store electronic mail messages. The mail server operates by receiving and storing mail messages from a first computer that are intended for receipt by a second computer. The second computer may then retrieve the electronic messages from the mail server at a time when the second computer is not occupied with other tasks. The mail messages may, as an example, be transferred within the network as described above by way of the routers and other network components.

Many networks include an administrator computer (often referred to simply as an administrator) that directs the data transfers between the different computers within the network. For example, the administrator may program the nodes, such as the routers, to achieve the most efficient communications between the computers within the network. The administrator may also use various programs to monitor the amount of data being transferred on the different routers. The administrator may then reroute the data communications in a manner so as to alleviate overcrowding and, thus, reduce latency associated with a specific router.

One problem with networked computers is that excessive data transfers or the failure of a device, such as a router, increases the latency of the network. As the latency increases, the computers within the network become less efficient and the time required to transfer data on the network increases. This problem is exacerbated because the operator of the administrator computer generally has no way to determine that a problem exists with the network until the network users notify the operator of the administrator computer. By the time the operator of the administrator computer is notified of the problem, the data transfer rates of the network have typically slowed considerably, which substantially decreases the efficiency of the network.

In many situations, data transfers within the network are guaranteed or otherwise contracted to be within preselected time limitations. By the time users notify the user of the administrator computer that problems exist, the time limitations for data transfers have been exceeded. Accordingly, the guarantee or contract has been breached.

Therefore, a need exists for a device or method that overcomes some or all of these problems.

### SUMMARY OF THE INVENTION

The present invention is directed toward automatically monitoring response times within a network. The network may provide for the transmission of data between a computer and an electronic device, such as a second computer, e.g., a mail server. The network may have a plurality of nodes, such as routers, switches, transmission lines and other devices, that may serve to direct the data between the computer and the electronic device.

A monitoring program may reside on at least one of the devices within the network and may serve to notify a network administrator of excessive latency within the network. In the examples provided herein, the monitoring program resides and runs on a computer within the network. The monitoring program may cause a trace route program to operate, which in turn causes ping routines to be run. The monitoring program receives data from the trace route program indicative of the time responses required to transfer data between the computer and another device. The time responses measured by the trace route program are then compared to preselected time responses associated with the monitoring program. If a measured time response exceeds its respective preselected time response, a message is transmitted to an administrator or the like indicating that a segment within the network is experiencing time response problems.

The message sent to the administrator may cause a video display to display a view of the network with the segment experiencing the problems highlighted. For example, the network may be displayed graphically with the segment experiencing the problem displayed in a contrasting color. Textual information may also be displayed indicating the preselected time response of the segment and the measured time response of the segment.

### BRIEF DESCRIPTION OF THE DRAWINGS

FIG. 1 is a schematic illustration of a computer network.

FIG. 2 is a flow chart illustrating the method of monitoring the network of FIG. 1.

### DETAILED DESCRIPTION OF THE INVENTION

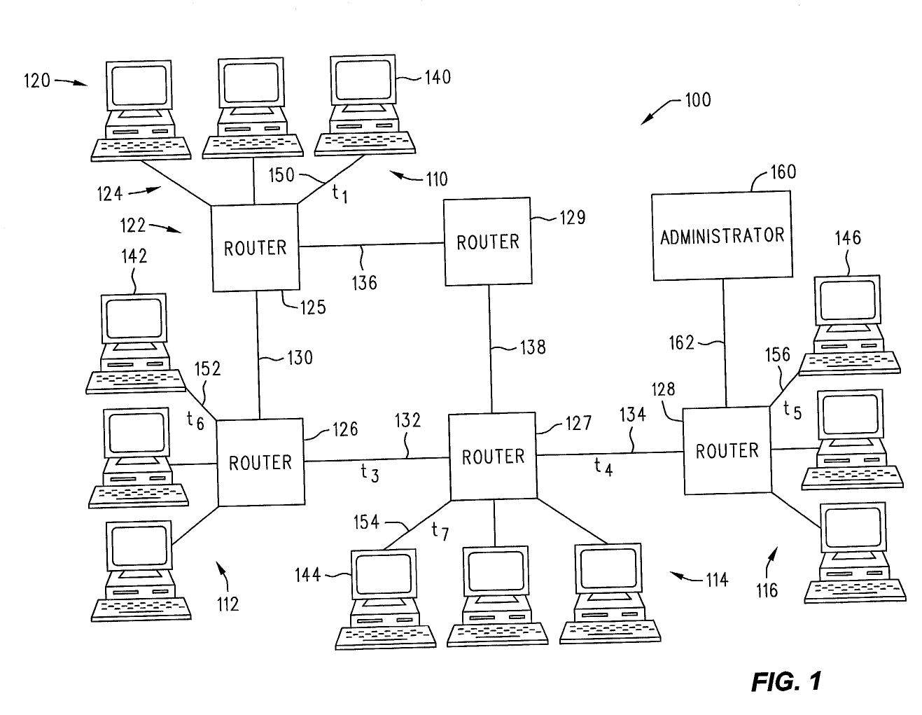

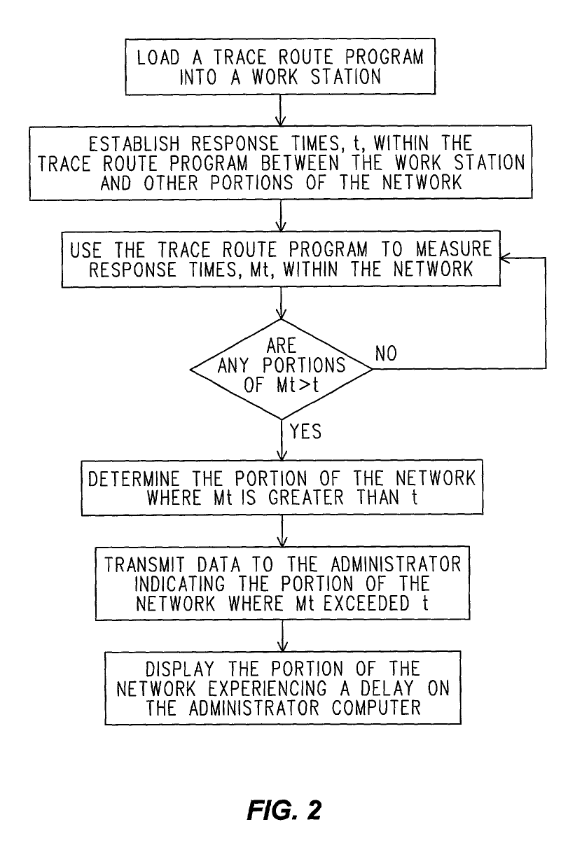

FIGS. 1 and 2, in general, illustrate an electronic network 100 that may have a first electronic device 142 associated with a second electronic device 146. The association provides for the transfer of data between the first electronic device 142 and the second electronic device 146. The first electronic device 142 may be adapted to measure the response time of data transfers between the first electronic device 142 and the second electronic device 146. The first electronic device 142 may also be adapted to compare the measured response time to a preselected response time and provide an indication if the measured response time is greater than the preselected response time.

FIGS. 1 and 2 also, in general, illustrate a method for monitoring a computer network 100, wherein the computer network 100 is of the type comprising at least one electronic device 122 operatively associated between a first computer 142 and a second computer 146. The method may comprise establishing a first preselected data transfer time between the first computer 142 and the at least one electronic device 122. In addition, a second preselected data transfer time between the at least one electronic device 122 and the second computer 146 may be established. A first actual data transfer time between the first computer 142 and the at least one electronic device 122 may be measured. Likewise, a second actual data transfer time between the at least one electronic device 122 and the second computer 146 may be measured. The first preselected data transfer time may be compared to the first actual data transfer time and the second preselected data transfer time may be compared to the second actual data transfer time. An indication may be provided if either the first actual data transfer time is greater than the first preselected data transfer time or if the second actual data transfer time is greater than the second preselected data transfer time.

Having generally described the network 100 and a method of monitoring the network 100, they will now be described in greater detail.

A schematic illustration of a non-limiting example of a network 100 is shown in FIG. 1. For illustration purposes, the network 100 is divided into a first network portion 110, a second network portion 112, a third network portion 114, and a fourth network portion 116. The network portions are sometimes referred to as subnetworks or subnets. Each of the network portions may have a plurality of computers 120 operatively associated with at least one router 122 or other electronic data transfer device by way of a data line 124. Accordingly, the network 100 may have a first router 125 associated with the first network portion 110, a second router 126 associated with the second network portion 112, a third router 127 associated with the third network portion 114, and a fourth router 128 associated with the fourth network portion 116. The routers 122 may be electronic devices that are used to interconnect the computers 120 in a conventional manner. The computers 120 and routers 122 are sometimes referred to as nodes within the network 100.

In addition to the above-described routers 122, the network 100 may have a fifth router 129 associated therewith. The fifth router 129 may be electrically connected to the first router 125 by way of a data line 136. The fifth router 129 may also be electrically connected to the third router 127 by way of a data line 138. The fifth router 129 may be connected to other portions of the network 100 that are not shown in FIG. 1, such as other computers and routers.

In the non-limiting embodiment described herein, the first router 125 is connected to the second router 126 by a data line 130. The second router 126 is connected to the third router 127 by a data line 132. The third router 127 is connected to the fourth router 128 by a data line 134. The above-described data lines are for illustration purposes only. It is to be understood that other transmission means, such as optics and radio frequencies may be used to connect or otherwise operatively associate the routers 122 with each other. The links between the individual routers and the links between the computers 120 and the routers 122 are sometimes referred to as hops or segments.

The computers 120 are sometimes referred to as workstations, clients, and users. The computers 120 may, as a non-limiting example, be conventional personal computers that are adapted to be connected to the network 100. In the non-limiting example provided in FIG. 1, the computers 120 are electrically connected to the routers 122 by way of the data lines 124. It should be noted, however, that other means, such as optics and radio frequencies, may be used to operatively associate or otherwise connect the computers 120 to the routers 122.

For illustration purposes, reference is made to a first computer 140 located within the first network portion 110, a second computer 142 located within the second network portion 112, a third computer 144 located within the third network portion 114, and a fourth computer 146 located within the fourth network portion 116. The first computer 140 is connected to the first router 125 by way of a data line 150. The second computer 142 is connected to the second router 126 by way of a data line 152. The third computer 144 is connected to the third router 127 by way of a data line 154. The fourth computer 146 is connected to the fourth router 128 by a data line 156. It should be noted that the above-described computers and data lines are representative of all the computers 120 and data lines 124 in the network 100. It should also be noted that other devices, not shown, may be located within the data lines 124. Accordingly, the computers 120 may not be directly connected to the routers 122 and may be referred to as being operatively connected to the routers 122.

An administrator 160 may be connected to the third router 127 by way of a data line 162. The administrator 160 may be a conventional personal computer that is adapted to program and communicate with the routers 122. As described in greater detail below, the administrator 160 may also have the ability to monitor the amount of data being transmitted within the network 100 through its ability to communicate with the routers 122. As stated above, the administrator 160 is illustrated as being associated with the fourth router 128 however, it is to be understood that the administrator 160 may be associated with virtually any node or router 122 within the network 100.

The administrator 160 may also run a program that analyzes the network 100 so as to display the nodes within the network 100. For example, the program may monitor the routers 122 to determine how they are connected to each other. The program may then display this information in a graphical format. Examples of such programs are disclosed in the U.S. Pat. No. 5,185,860 of We for AUTOMATIC DISCOVERY OF NETWORK ELEMENTS and U.S. Pat. No. 5,276,789 of Besaw et al. for GRAPHIC DISPLAY OF NETWORK TOPOLOGY, both of which are hereby incorporated by reference for all that is disclosed therein. The administrator 160 may additionally run a program that determines the network paths within the network 100. An example of such a program is disclosed in the U.S. patent application Ser. No. 09/694,843 of Natarajan et al. for SYSTEM AND METHOD FOR DETERMINING PROBABLE NETWORK PATHS BETWEEN NODES IN A NETWORK TOPOLOGY, filed on Oct. 23, 2000 (attorney docket number 10004526-1), which is hereby incorporated by reference for all that is disclosed therein.

The administrator 160 may have the ability to program the routers 122 and other network devices so as to regulate the transfer of data within the network 100. For example, if one of the routers 122 is experiencing problems, the administrator 160 may reprogram it. The administrator 160 may also direct data transfers through other routers to avoid the router experiencing the problems. With reference to FIG. 1, if the second router 126 experiences problems, some data may be rerouted through the fifth router 129 in order to avoid the second router 126. The administrator 160 may also have the ability to run programs within the individual computers 120 as is described in greater detail below.

Having described the physical components of the network 100, the transfer of data within the network 100 will now be described.

The data transmitted or otherwise transferred within the network 100 is typically transmitted as a plurality of data packets. Each data packet has routing information, which is read by the routers 122 so that the data may be transmitted to the appropriate computer 120. The routing information is sometimes referred to as the internet protocol (IP). The routers 122 have data stored therein that manages the transfer of the data between the individual routers 122. For example, the second router 126 may have data stored therein indicating that it is connected to the first router 125 via the data line 130 and that it is connected to the third router 127 via the data line 132. The second router 126 may also have data stored therein that is indicative of the other routers and computers located within the network 100. This information is used by the second router 126 to direct the data packets to their appropriate destinations. For example, when a data packet arrives from the first router 125 and is intended to be transmitted to the fourth computer 146, the second router 126 reads the routing information and transmits the data packet along the data line 132 to the third router 127. The third router 127 and the fourth router 128 function in similar manners to ultimately route the data packet to the fourth computer 146. The second router 126 may also change the routing information to efficiently route the data packet to its destination.

The routing information may also contain information pertaining to the number of hops the data packet has undergone. The data packet may be discarded after it has undergone a preselected number of hops. For example, if the routing information associated with a data packet indicates that it has undergone more than the preselected number of hops, the data packet is erased and a message is sent back to the originating computer indicating that the data packet was discarded. In addition, the message sent back to the originating computer may include the location of the data packet, the number of hops the data packet underwent, and the time the data packet was in the network. The preselected number of hops permitted by the data packet is sometimes referred to as the time-to-live value or simply the TTL. The message transmitted back to the originating computer upon the erasure of the data packet may, as an example, be an internet control message protocol.

If any of the aforementioned routers 122 are experiencing delays or other anomalies, the transmission of data between the computers 120 within the network 100 will likely be delayed. This delay is often referred to as an increase in the response time, data transit time, or latency in the network 100. The increased response time may, as an example, be caused by excessive data transmissions through one of the routers 122. Accordingly, the data packets will be cued until time is available to transmit them. The increased response time may also be caused by one of the routers 122 experiencing a software or hardware fault that hinders its ability to properly transmit data.

In a conventional computer network, when a computer user experiences delays, the computer user has to contact a network administrator to report the delays. The network administrator must then analyze the operating conditions of the network components to determine the source of the delays. By the time the administrator has analyzed the delay problems, they often have increased and are burdening many users. In some situations, the delays are minimal, resulting in minimal increased response times that may only cause slight delays that are not noticed by a single user. The slight delays may, taken as a whole, substantially decrease the efficiency of the network 100.

The method described herein, in summary, overcomes the problems within conventional networks of relying on users to report latency problems. This is achieved by continually and automatically monitoring response times within the network. When a response time exceeds a preselected response time specification, the administrator is alerted to the problem. Accordingly, minor latency problems within the network can be resolved before they escalate into serious problems. The method described herein is further illustrated by the flowchart of FIG. 2.

Having described the network 100 and some of the problems associated with conventional networks, the method of automatically monitoring network response times will now be described.

In the method described herein, the administrator 160 has the ability to run a program on at least one of the computers 120 within the network 100. Accordingly, the administrator 160 has the ability to receive results generated by the program running on the computers 120 within the network 100. The program run by the administrator 160 on the computers 120 is sometimes referred to as an agent or a probe.

In the example provided herein, a monitoring program may be running on the first computer 140. The monitoring program causes a trace route program or the like may be loaded onto and running on the first computer 140. In a non-limiting example of the network 100, the administrator 160 loads the monitoring program onto the first computer 140 as is described below. The monitoring program causes the trace route program to measure the response times associated with specific paths within the network 100. The trace route program may, as an example, execute a packet internet groper (ping) program or the like which determines the response times between the first computer 140 and another computer, sometimes referred to as the target computer. The trace route program may, as an example, transfer a series of data packets to a target computer. The series of data packets may have increasing TTL values. For example, the first data packet may be transmitted via the trace route program and may have TTL value of one. The data packet will be discarded after the first hop and information detailing the location and response time of the first hop will be returned to the originating computer. Subsequent data packets may be sent via the trace route program to collect data regarding other hops within the network 100.

The monitoring program may establish maximum response time specifications for specific hops within the network 100. For example, the administrator 160 may create data tables or the like within specific computers 120 that set the maximum response time specifications between specific hops. The computers 120 then automatically measure the response times between nodes within the network 100 by running the monitoring program. For example, the computers 120 may periodically run the monitoring program to test the response times within the network 100. The response times measured by the monitoring program are then compared to the response times specified by the administrator 160. If a measured response time exceeds the response time specification established by the administrator 160, a signal is sent to the administrator 160 notifying the administrator 160 of the excessive time. A display device associated with the administrator 160 may display information indicating the location of the hop having an excessive response time. The display device may also display the measured time response versus the time response established by the administrator 160. Accordingly, the administrator 160 is automatically notified of latency problems.

The information displayed on the display device may include a graphical representation of the network 100. Portions of the network 100 that are experiencing delays may be highlighted or otherwise distinguishable from portions of the network 100 that are functioning properly. For example, portions of the network 100 that are operating properly may be displayed in a first color and portions of the network 100 that are experiencing delays may be displayed in a second color. Examples of displaying network paths are disclosed in the U.S. Pat. Nos. 5,185,860 and 5,276,789 which were previously referenced. The examples in the U.S. Pat. Nos. 5,185,860 and 5,276,789 patents may be modified to distinguish portions of the network 100 as described above.

Having described monitoring, an example of using the monitoring program will now be described. An example is described below with reference to the computers 120 accessing the fourth computer 146, which is described herein as being a mail server.

In the following example, the administrator 160 establishes preselected response time specifications between the first computer 140 and the fourth computer 146. The administrator 160 also establishes preselected response time specifications between the second computer 142 and the fourth computer 146 along with response time specifications between the third computer 144 and the fourth computer 146. It should be noted that these preselected response time specifications are for illustration purposes only and that the response time specifications between virtually any of the computers 120 within the network 100 may be established by the administrator 160. It should also be noted that the administrator computer 160 may establish response time specifications between any nodes within the network 100.

The administrator 160 may establish the following response time specifications between the first computer 140 and the fourth computer 146:

t1: between the first computer 140 and the first router 125;

t2: between the first router 125 and the second router 126;

t3: between the second router 126 and the third router 127;

t4: between the third router 127 and the fourth router 128; and

t5: between the fourth router 128 and the fourth computer 146.

In order to establish the time response specification between the second computer 142 and the fourth computer 146, the administrator 160 only needs to add a response time specification, t6, between the second computer 142 and the second router 126 to the above-described response time specifications. Likewise, in order to establish the time response specification between the third computer 144 and the fourth computer 146, the administrator 160 only needs to add a response time specification, t7, between the third computer 144 and the third router 127 to the above-described response time specifications.

It should be noted that the above-described response time specifications may, as a non-limiting example, be the round trip time for a data packet. For example, the response time specifications may be the time between when a first device outputs a data packet to a second device and when the second device returns the data packet back to the first device. It should be noted that other definitions of the response time are applicable to the monitoring program disclosed herein.

Monitoring programs may run on the computers 120 and may monitor the actual response times measured by the aforementioned trace route program. It should be noted that the above-described trace route program and the monitoring programs may be combined into single programs that run on the individual computers 120. Trace route programs run on the individual computers 120 and measure the aforementioned response times associated with the hops within the network 100. The measured response times are output to the monitoring program, which compares the measured response times to the aforementioned preselected response time specifications. In the example described herein where the first computer 140 communicates with the fourth computer 146, the measured response times are referred to as Mt1 through Mt5 and correspond to the preselected time response specifications for the hops designated by t1 through t5. A measured response time Mt6 corresponds to the preselected response time specification of t6 and a measured response time Mt7 corresponds to the preselected response time specification of t7.

In the example cited herein, it is assumed for illustration purposes that a problem exists with the second router 126 that increases response times of data transmissions associated with the second router 126. It is further assumed that all the other routers 122 are functioning properly. As the network 100 is monitored, the first computer 140 runs the above-described monitoring program and determines that the response time for the hop between the first computer 140 and the first router 125 designated by the response time specification t1 is within the preselected specification.

When the monitoring program runs the trace route routine with a TTL value of two, the measured time response, Mt2, to the second router 126 exceeds the preselected time response specification t2. All the trace route routines directed to the subsequent routers will exceed their preselected response time specifications because they are in the path of the second router 126. The individual hops between other portions of the network 100, however, may be within the preselected time response specifications. For example, Mt4 and Mt5 may be less than their respective preselected time response specifications t4 and t5. It should be noted that the problem with the second router 126 may also cause the measured time Mt3 to exceed its preselected time response specification t3. The monitoring program may then cause an indication of the excessive time responses to be transmitted to the administrator 160 as is described below.

The second computer 142 may also run the trace route program as it monitors the network 100. The measured response time Mt6 between the second computer 142 and the second router 126 will exceed the response time specification t6 due to the above-described failure of the second router 126. As with the trace route program running on the first computer 140, the measured time responses in segments of the network 100 after the second router 126 may be less than the response time specifications. The monitoring program may also run a trace route program on the third computer 144. Because the second router 126 is not in the line between the third computer 144 and the fourth computer 146, none of the measured time responses will be greater than their respective time response specifications.

The monitoring programs resident within the computers 120 will compare the above described measured response times with the preselected response time specifications. In order to continually monitor the network 100, the monitoring programs may measure the response times and compare them to their respective preselected response time specifications at preselected intervals, e.g., every few seconds. During the comparison, the monitoring program resident on the first computer 140 determines that the measured response time, Mt2, is greater than is respective response time specification, t2. The measured response time, Mt3, may also be greater than its response time specification, t3, due to the second router 126 having problems. The remaining hops denoted as t1, t4 and t5 will be within specification. The monitoring program resident on the second computer 142 will indicate that the measured response time Mt6 and possibly Mt3 have exceeded their respective preselected response time specifications, t6 and t3. The monitoring program resident on the third computer 144 will not find any delay problems because there are no problems between the third computer 144 and the fourth computer 146.

When the monitoring program measures time responses greater than the aforementioned preselected time response specifications, they send indications of the excessive measured time responses to the administrator 160. The indication may include the hop within the network 100 that experienced the excessive time response, the actual measured time response, and the time response specification. In one example, a screen may be displayed on the administrator 160 indicating that a problem exists and detailing the location of the problem.

The screen displayed on the administrator 160 may have several different embodiments. In one embodiment, a graphical representation of the network 100 is displayed wherein portions of the network 100 experiencing problems are displayed in a distinguishable format. For example, the portions of the network 100 experiencing problems may be displayed in contrasting colors. The display may also be integrated into a program that displays a network topology. For example, the screen may be substantially similar to or incorporated into products sold by the Hewlett-Packard Company under the trade name Openview and Network Node Manager.

Having described some embodiments of the monitoring program, other embodiment will now be described.

In one embodiment of the network 100, communications are performed via the hypertext transfer protocol (HTTP). The use of HTTP allows communications to be performed through firewalls. In many network applications, a portion of the network may be protected by a firewall that limits communications through the firewall. The use of HTTP overcomes communications problems associated by the firewalls and, as stated above, permits communications through the firewalls.

In another embodiment of the monitoring program, the comparisons of the measured response times to the preselected response time specifications are performed by the administrator 160. For example, the individual computers 120 may measure the response times and transmit the response times to the administrator 160. The administrator 160 may then compare these measured response times to preselected response time specifications.

While an illustrative and presently preferred embodiment of the invention has been described in detail herein, it is to be understood that the inventive concepts may be otherwise variously embodied and employed and that the appended claims are intended to be construed to include such variations except insofar as limited by the prior art.

What is claimed is:

1. An electronic network comprising:
a first electronic device associated with a second electronic device, said association providing for the transfer of data between said first electronic device and said second electronic device; said first electronic device being adapted to:
measure the response time of data transfers between said first electronic device and said second electronic device;
compare the measured response time to a preselected response time; and
provide an indication if said measured response time is greater than said preselected response time.

2. The electronic network of claim 1, wherein said first electronic device is a computer.

3. The electronic network of claim 1 and further comprising a computer associated with said first electronic device, said computer being adapted to establish said preselected response time within said first electronic device.

4. The electronic network of claim 1 and further comprising a computer associated with said first electronic device, said first electronic device providing said indication to said computer.

5. The electronic network of claim 1, and further comprising at least one third electronic device operatively connected between said first electronic device and said second electronic device, and wherein said response time is a plurality of response times between said first electronic device and said at least one third electronic device and between said at least one third electronic device and said second electronic device.

6. The electronic network of claim 1, wherein said first electronic device is adapted to measure the response time of data transfers between said first electronic device and said second electronic device and compare the measured response time to said preselected response time at preselected time intervals.

7. The electronic network of claim 1, wherein said indication includes said measured response time.

8. A computer network comprising:
a first computer associated with at least one first electronic device, the association providing for the transfer of data between said first computer and said at least one first electronic device;
said first computer having a computer-readable medium associated therewith, said computer-readable medium containing instructions for controlling said first computer to monitor said network by:
measuring the response time of data transfers between said first computer and said at least one first electronic device;
comparing the measured response time to a preselected response time; and
providing an indication if said measured response time is greater than said preselected response time.

9. The computer network of claim 8 and further comprising a second computer operatively connected to said first computer, said second computer having a computer-readable medium associated therewith, said computer-readable medium containing instructions for establishing said preselected time response in said first computer.

10. The computer network of claim 8 and further comprising a second computer operatively associated with said first computer, said second computer having a computer-readable medium associated therewith, said computer-readable medium containing instructions for receiving said indication from said first computer.

11. The computer network of claim 10, wherein said computer-readable medium of said second computer contains instructions for displaying a graphical representation of said network, wherein the portion of said network causing said measured response time to exceed said preselected response time is distinguishable from other portions of said representation of said network.

12. The computer network of claim 8, wherein said computer-readable medium measures said response time and compares said response time to said preselected response time at a preselected time interval.

13. The computer network of claim 8, wherein said indication includes said measured response time.

14. The computer network of claim 8, wherein said indication includes said preselected response time.

15. The computer network of claim 8 and further comprising at least one second electronic device operatively connected between said first computer and said at least one first electronic device.

16. The computer network of claim 15, wherein said at least one second electronic device is a router.

17. A method for monitoring a computer network, said method comprising:
establishing a preselected data response time between a first computer and at least one first electronic device;
measuring the actual data response time between said first computer and said at least one first electronic device;
comparing said preselected data response time to said actual data response time; and
providing an indication if said actual data response time is greater than said preselected data response time.

18. The method of claim 17, wherein said establishing a preselected data response time further comprises using a second computer to establish a preselected data response time in said first computer.

19. The method of claim 17, wherein said providing an indication comprises providing and indication to a second computer if said actual data response time is greater than said preselected data response time.

20. The method of claim 17, wherein said at least one first electronic device is a router.

21. The method of claim 17, wherein said at least one first electronic device is a computer.

22. The method of claim 17, wherein said measuring and said comparing are performed at preselected time intervals.

23. The method of claim 17, wherein said providing an indication further comprises providing said measured response time.

24. The method of claim 17, wherein said providing an indication further comprises providing said preselected response time.

25. A method for monitoring a computer network, wherein said computer network is of the type comprising at least one electronic device operatively associated between a first computer and a second computer, said method comprising:
establishing a first preselected data transfer time between said first computer and said at least one electronic device;
establishing a second preselected data transfer time between said at least one electronic device and said second computer;
measuring a first actual data transfer time between said first computer and said at least one electronic device;
measuring a second actual data transfer time between said at least one electronic device and said second computer;
comparing said first preselected data transfer time to said first actual data transfer time;
comparing said second preselected data transfer time to said second actual data transfer time; and
providing an indication if either said first actual data transfer time is greater than said first preselected data transfer time or if said second actual data transfer time is greater than said second preselected data transfer time.

26. A method for monitoring a computer network, wherein said computer network is of the type comprising at least one electronic device operatively associated between a first computer and a second computer, said method comprising:
establishing a first preselected data transfer time between said first computer and said at least one electronic device;
establishing a second preselected data transfer time between said at least one electronic device and said second computer;
executing a trace route routine to measure a first actual data transfer time between said first computer and said at least one electronic device;
executing a trace route routine to measure a second actual data transfer time between said at least one electronic device and said second computer;
comparing said first preselected data transfer time to said first actual data transfer time;
comparing said second preselected data transfer time to said second actual data transfer time; and
providing an indication if either said first actual data transfer time is greater than said first preselected data transfer time or if said second actual data transfer time is greater than said second preselected data transfer time.

27. A computer network monitoring device comprising:
measuring means for measuring the data response time between a first computer and at least one electronic device;
comparing means for comparing the measured data response time between said first computer and said at least one electronic device to a preselected data response time; and
indicating means for providing an indication if said measured data response time is greater than said preselected data response time.
